(19) United States
(12) Patent Application Publication
(10) Pub. No.: US 2002/0036879 A1
(43) Pub. Date: Mar. 28, 2002

(54) Secure integrated electronic device

(76) Inventors: Francois Vacherand, Le Pont-De-Claix (FR); Elisabeth Crochon, Poisat (FR)

Correspondence Address: Robert E. Krebs, BURNS, DOANE, SWECKER & MATHIS, L.L.P., P.O. Box 1404, Alexandria, VA, 22313-1404, US

(21) Appl. No.: 09/955,179

(22) Filed: Sep. 19, 2001

(30) Foreign Application Priority Data
Sep. 20, 2000 (FR) 0011970

(51) Int. Cl. H02H 3/08

(52) U.S. Cl. 361/93.1

(57) ABSTRACT

This invention relates to a secure integrated electronic device comprising

a processing unit (10) containing a logical processor and a non-volatile memory,

an energy source (11),

at least one sensor (12, 13, 14) capable of measuring a determined physical magnitude and supplying a value representative of this magnitude,

means (15, 16, 17) of comparison of each value with at least one predefined threshold (ref1, ref2, ref3) giving result signals,

a device (20) for protection of the processing unit,

a logical device (21) for making decisions capable of activating the protection device after seeing the result signals.

### TECHNICAL DOMAIN

This invention relates to a secure integrated electronic device, for example a smart card.

### STATE OF PRIOR ART

The power supply to smart cards according to prior art is applied when the card is inserted in a reader. This is the only time at which an active protection can be provided. There is no way that these cards can detect an invasive attack when there is no power supply applied to the circuit. Therefore a reverse engineering attack made by a dishonest person to retrieve confidential information memorised on this card, for example encryption keys and the personal identification code, would has a good chance of succeeding.

A smart card circuit can be surrounded by a mesh of conductors according to the known method described in document reference [1] at the end of the description, in order to detect any prejudicial or even criminal intrusion in a smart card circuit. But this detection is only possible if a power supply is applied to the circuit.

Therefore, the purpose of the invention is to solve this detection problem to enable protection of sensitive information recorded in a secure integrated electronic device such as smart card; this protection may be destruction or erasure of this information, regardless of whether or not the device is inserted in a reader.

### PRESENTATION OF THE INVENTION

This invention relates to a secure integrated electronic device, for example a smart card comprising a processing unit containing a logical processor and a non-volatile memory, characterized in that it comprises:

an energy source,

at least one sensor capable of measuring a given physical magnitude and outputting a value representative of this magnitude,

means of comparison of each value with at least one predefined threshold giving result signals,

a device for protection of the processing unit,

a logical decision making device capable of activating the protection device after seeing the signals resulting from the comparison.

The energy source may be integrated into the processor. It may also be a battery.

Each sensor may be capable of measuring a physical magnitude characterizing the processor or the processor environment, or a sensor capable of measuring a physical magnitude characterizing communication coming into or out of the said device.

Active monitoring is possible with this device, in other words permanent measures can be made of physical parameters characterizing normal operation, and then information can be protected by the protection device whenever necessary.

In one particular embodiment, the device according to the invention comprises a sensor capable of detecting when the power supply circuit from the energy source to the logical processor source is broken, a contact free energy transfer device from the energy source to the processor and a device that triggers this transfer. This sensor is able to measure a physical magnitude characterizing the electrical connection between the logical processor and the energy source. The contact free energy transfer device may comprise two coils placed on each side of the electrical connection between the logical processor and the energy source.

### BRIEF DESCRIPTION OF THE DRAWINGS

FIG. 1 illustrates the device according to the invention.

FIG. 2 illustrates a particular embodiment of the invention.

### DETAILED DESCRIPTION OF EMBODIMENTS

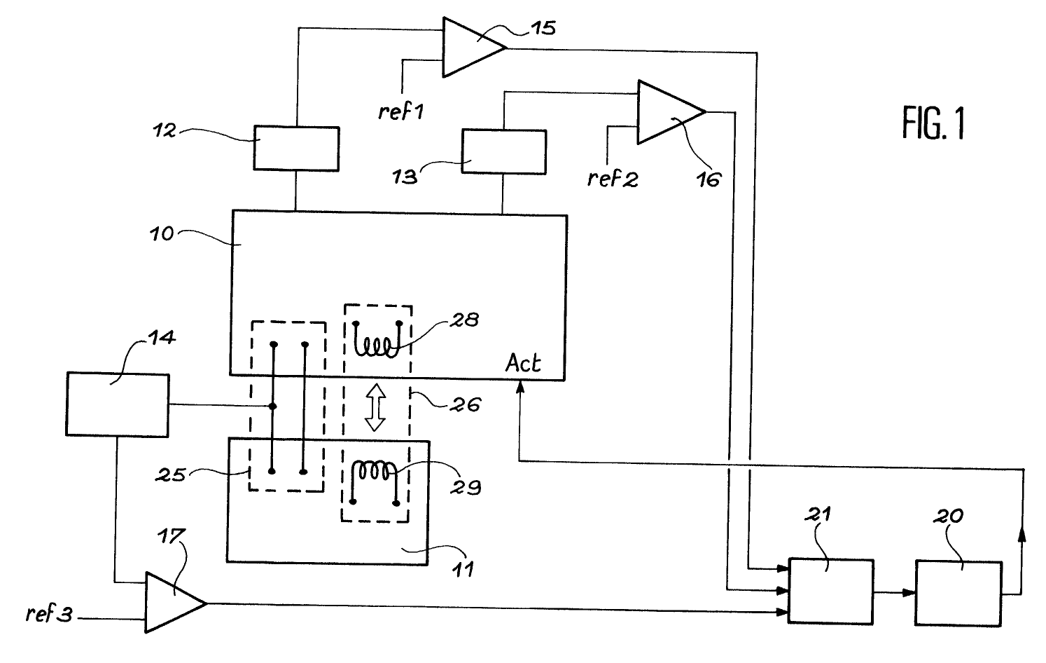

As illustrated in FIG. 1, the device according to the invention comprises:

an energy source 11,

an integrated circuit 10, or a processing unit, particularly containing a logical processor and a nonvolatile memory,

at least one sensor capable of measuring a given physical magnitude and outputting a value representative of this magnitude, there being three of these sensors, 12, 13, 14,

means of comparing each measured value with a predetermined threshold, in this case made by three comparators 15, 16, 17 receiving signals ref1, ref2, ref3 respectively on one of their inputs and the output from the corresponding sensor 12, 13 or 14 on the other input,

a device 20 for protection of the processing unit 10, the output of which is connected to an Act (action) input on the device.

a logical decision making device 21 capable of activating the protection device 20 receiving output signals from comparators 15, 16 and 17.

Therefore this secure integrated electronic device according to the invention uses two active functions:

an intrusion detection function,

a safeguard function at all times, in other words regardless of whether or not it is inserted in a reader.

We will now consider each of these elements of the device according to the invention.

The processing unit 10 that contains a processor and a non-volatile memory is the unit that is conventionally found in the smart cards. It contains the following functions:

a Central Processing Unit (CPU),

a read only memory (ROM),

a volatile work memory (RAM),

a non-volatile storage memory (EEPROM),

a communication interface, with contact or contact free, that supplies:

the circuit power supply (external),

a two directional communication channel,

possibly a clock,

and possibly a reset processor signal.

It may also contain other functions, for example sensor, comparator and logic functions.

The energy source 11 may be a micro-battery such as a button battery, ultra-flat battery, integrated battery, etc. It must be capable of supplying power to the device according to the invention to implement the active intrusion detection function and the protection activation function.

This energy source 11 may also be made using processes derived from microelectronics, for example by adding three technological levels or more above the levels typically dedicated to production of the integrated circuit 10: these three levels being used to collectively produce the energy source 11, connections and the solid state electrolyte.

The energy source 11 may also be external to the integrated circuit 10.

Sensors may be:

environment monitoring sensors; these sensors must verify if the nominal conditions of use (circuit powered through the communication channel) and rest conditions for the circuit are actually satisfied. Any detected difference from a reference value means that an intrusion attempt is being made. In particular, these sensors may be:

a temperature sensor to protect the energy source 11,

an ultraviolet rays sensor, for example to detect aggression on the EEPROM memory,

an X-rays sensor, to detect a radiography type aggression on the integrated circuit 10,

a protection mesh to detect an attempt at reverse engineering,

an electric or magnetic field sensor (antenna, etc.),

sensors monitoring the communication link. This type of sensor electronically monitors what is happening on the communication line. For example:

monitoring the power supply voltage,

monitoring the clock signal.

Other functions are also possible for:

recharging the energy source 11, if it is a battery, through the communication line. A battery recharge function can be included inside the device according to the invention, regardless of whether the communication is made with contact or if it is contact free.

activating/deactivating the device according to the invention. In some applications, it may useful to control use of the energy source. A start/stop remote control is then possible through the communication channel.

Thus, as shown in FIG. 1, the first and second sensors 12, 13 may for example be ultra-violet and X-ray sensors, and the third sensor 14 may be a sensor to detect the impedance measurement of the galvanic connection 25 between the source 11 and the processing unit 10.

The purpose of the comparison means is to regularly inspect the various parameters output from the sensors 12, 13, 14 and to compare them with the different reference values ref1, ref2 and ref3.

For example, comparators 15, 16 and 17 may be operational amplifiers; the reference values ref1, ref2 and ref3 are either internal or are imposed from outside or by the microprocessor.

These comparison means may also detect:

firstly, a low energy level (first threshold) to give an alarm that a maintenance operation is necessary. If the energy source is a rechargeable battery, the objective is to detect the load level below which a warning recharge request signal should be output,

secondly, a critical energy level (second threshold) to produce an alert and to implement the protection. Since the energy remaining below this second threshold is only just sufficient to activate protection, it is triggered to guarantee security.

The protection device 20 protects confidential information. This protection may consist of:

resetting all memories,

physical destruction of vital connections,

start-up of a contact free connection 26 between the energy source 11 and the processing unit 10.

The main objective for electronic circuits in smart cards is to erase the contents of the memories in which encryption and identification keys are stored.

These different elements may form a “protected” area which is supposed to be composed of a circuit considered to be unbreakable. The links between the different functions (chip, energy source, sensors) are then valid at all times and cannot be attacked or modified. But it is also possible to:

either detect that a sensor 12, 13 and 14 is disconnected by checking that the direct measurement is incorrect, or by making calibration means,

or get around disconnection of the energy source 11 by transmitting energy in other ways, at least temporarily.

### SPECIAL CASE OF DISCONNECTION OF THE ENERGY SOURCE 11

In this particular embodiment, the device according to the invention is used to associate the logical processor and the memory with a sensor 14 capable of detecting if the power supply circuit is interrupted, a contact free energy transfer device 26 transferring energy from the energy source 11 to the processor, and a device to trigger this transfer.

For example, the contact free energy transfer device 26 comprises two coils 28 and 29 placed on each side of the electrical connection between the processor and the energy source that makes an inductive connection capable of transferring energy from one to the other. These coils are not necessarily immediately adjacent to each other, they may be at some distance from each other and form an inductive link.

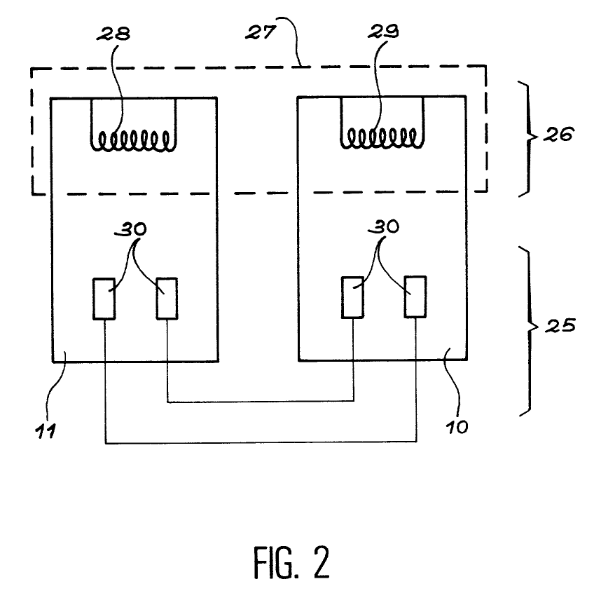

As illustrated in FIG. 2, a bar made of a ferrite type material 27 may connect two coils 28 and 29 for correct magnetic coupling. It is always possible to detect either a break in the galvanic link by an impedance measurement, or withdrawal of the ferrite bar 27 (or a modification of the coupling) by a variation of the inductance of one of the coils 28 or 29.

The power supply to the electronic device 10 (or more precisely the active monitoring circuit) is normally made through the galvanic link 25. If this galvanic link is broken, the device instantaneously redirects the energy transfer through the inductive link 26. If the contact free link is defective, all that is transferred through the galvanic link 25 is an alarm signal to decide upon protection of the device.

As shown in FIG. 2, the galvanic link 25 comprises pads 30. It performs the following functions:

power supply (+pole and −pole),

two-directional transmission of information by carrier current (modulation/demodulation),

detection of load presence, otherwise in the case of an open circuit, tear off detection alarm.

Additional pads could be used if the information transmission disturbs the power supply in some applications.

The protection of the galvanic link can be improved by surrounding the device with a galvanic contact “ring”. Thus, it will be possible to detect an attack from any direction intended to separate the energy source 11 from the processor.

The inductive link 26 comprises two coils 28 and 29, and performs the following functions:

remote power supply by carrier current at a suitable frequency,

two-directional transmission of information by modulation/demodulation of the carrier,

detection of load presence, otherwise in the case of an open circuit, tear off detection alarm.

Detection of separation of the energy source 11 circuit from the device 10 is based on a sudden change in the power supply load. As soon as a contact break is detected, the device reconfigures itself to send a maximum amount of energy through the inductive link 26. This supplies power to the device for a brief moment, but sufficient to provide the protection.

There are also several different possible variants in this embodiment:

when a battery is used for the power supply source 11, a battery recharge module can draw its power supply source either through the power supply of the electronic circuit when it is in a reader (it would be possible to add specific pads) or by remote power supply through inductive coupling using the coil that is already present.

a remote control to switch the energy source 11 on and off may be available through the communication channel. This may be provided either by galvanic coupling or by a contact free inductive coupling.

a temperature sensor may check if nominal usage conditions (device powered through the communication channel) and rest conditions for the device are actually satisfied. A detected difference then means either a potential intrusion attempt or an environment change that could be fatal for the energy source 11,

the storage memory may be located close to the energy source 11. If there is a sudden change in the connection between the power supply and the electronic device, the power supply will not have any difficulty in transmitting the energy to erase sensitive data. Transmission channels are used to exchange data with the device according to the invention during its use. Inductive coupling is no longer compulsory.

The energy source 11 can use the inductive link 26 to transmit an alarm message to the device according to the invention. This message is transmitted in the form of a signal modulating the carrier, and is decoded by the device that reacts accordingly.

### REFERENCES

[1] Design principles for tamper-resistant smart card processors” by Oliver Kömmerling and Mazkus G. Kuhn (Proceedings of the USENIX Workshop on smart card technology, Chicago, Ill., USA, May 10-11, 1999).

1. Secure integrated electronic device comprising a processing unit (10) containing a logical processor and a non-volatile memory, characterized in that it comprises:
an energy source (11),
at least one sensor (12, 13, 14) capable of measuring a determined physical magnitude and supplying a value representative of this magnitude,
means of comparison (15, 16, 17) of each value with at least one predefined threshold (ref1, ref2, ref3) outputting result signals,
a device (20) for protection of the processing unit,
a logical device (21) for making decisions capable of activating the protection device after seeing the result signals.

2. Device according to claim 1, in which the energy source (11) is integrated in the processor.

3. Device according to claim 1, in which the energy source (11) is a battery.

4. Device according to claim 1, in which at least one sensor is capable of measuring a physical magnitude characterizing the processor or the processor environment.

5. Device according to claim 1, in which at least one sensor is capable of measuring the physical magnitude characterizing communication coming into or out of the said device.

6. Device according to claim 1, in which a sensor is capable of measuring the energy level of the energy source to output a warning signal asking for a recharge or activation of the protection device.

7. Device according to claim 1 comprising a sensor capable of detecting a break in the power supply circuit between the energy source 11 and the logical processor, a contact free device (26) to transfer energy from the energy source (11) to the processor, and a device that triggers this transfer.

8. Device according to claim 7, in which this sensor is capable of measuring a physical magnitude characterizing the electrical link between the energy source (11) and the logical processor.

9. Device according to claim 7, in which the contact free energy transfer device (26) comprises two coils (28, 29) placed on each side of the electrical link between the energy source and the logical processor.

10. Device according to any one of the previous claims comprising a smart card.
